(19) United States
(12) Patent Application Publication
(10) Pub. No.: US 2025/0146386 A1
(43) Pub. Date: May 8, 2025

(54) METHODS FOR MANAGING PRESSURE BUILDUP WITHIN SUBSEA PRODUCTION EQUIPMENT USING COMPRESSIBLE PARTICLES

(71) Applicant: ExxonMobil Technology and Engineering Company, Spring, TX (US)

(72) Inventors: Sterling F. LEWIS, Hockley, TX (US); Elizabeth TEMPLETON-BARRETT, Houston, TX (US); Stephen C. HUHN, Houston, TX (US); Thomas A. PETERSEN, Houston, TX (US)

(21) Appl. No.: 18/837,167

(22) PCT Filed: Jan. 31, 2023
(86) PCT No.: PCT/US2023/061647

§ 371 Date: Aug. 8, 2024

Related U.S. Application Data
(60) Provisional application No. 63/267,815, filed on Feb. 10, 2022.

(51) Int. Cl. E21B 43/01; C09K 8/44; E21B 33/035

(52) U.S. Cl. CPC E21B 43/01; C09K 8/44; E21B 33/035

(57) ABSTRACT

Methods for managing pressure buildup within components of subsea production equipment using compressible particles are provided herein. An exemplary method includes positioning compressible particles within a fluid-filled closed volume defined within a component of subsea production equipment such that an increase in fluid pressure within the fluid-filled closed volume is attenuated by reversible volumetric contraction of the compressible particles.

### CROSS-REFERENCE TO RELATED APPLICATIONS

This application is the U.S. National Stage Application of the International Application No. PCT/US2023/061647, entitled “METHODS FOR MANAGING PRESSURE BUILDUP WITHIN SUBSEA PRODUCTION EQUIPMENT USING COMPRESSIBLE PARTICLES,” filed on Jan. 31, 2023, the disclosure of which is hereby incorporated by reference in its entirety, which claims the benefit of U.S. Provisional Application No. 63/267,815, filed Feb. 10, 2022, the disclosure of which is herein incorporated by reference in its entirety.

### FIELD OF THE INVENTION

The techniques described herein relate to the field of subsea production operations. More specifically, the techniques described herein relate to methods for managing pressure buildup within subsea production equipment using compressible particles.

### BACKGROUND OF THE INVENTION

This section is intended to introduce various aspects of the art, which may be associated with embodiments of the present techniques. This discussion is believed to assist in providing a framework to facilitate a better understanding of particular aspects of the present techniques. Accordingly, it should be understood that this section should be read in this light, and not necessarily as admissions of prior art.

More than two-thirds of the earth is covered by marine bodies or bodies of waters, such as oceans or lakes. As the petroleum industry continues its search for hydrocarbons, it is finding that more and more of the untapped hydrocarbon reservoirs are located beneath bodies of water, such as the oceans. Such reservoirs are referred to as “offshore reservoirs.”

A typical system used to produce hydrocarbons from offshore reservoirs uses hydrocarbon-producing wells located on the seabed or floor of the body of water (e.g., marine floor or ocean floor). This type of production system, often referred to as a subsea production system (SPS), generally includes a subsea tree, manifolds, intervention systems, subsea processing systems, and the corresponding pipeline system. The SPS is placed on the seabed to direct the flow of production fluids from the producing wells, often referred to as “producers” or “subsea production wells,” towards the flowlines, to isolate the flow from the wells, and to allow access to perform workovers and interventions. Moreover, the produced hydrocarbons are transported to a host production facility, which is located on the surface of the body of water or at onshore location.

The producing wells are in fluid communication with the host production facility via a system of pipes that transport the hydrocarbons from the subsea wells on the seabed to the host production facility. This system of pipes typically includes a collection of jumpers, flowlines, and risers (among other subsea production equipment). Jumpers include pipes that lie on the seabed and are used to connect the individual wellheads to a central manifold. Flowlines also lie on the seabed and are used to transport production fluids from the manifold to the riser. The riser extends from the seabed, through the water column, and to the host production facility. In many instances, the top of the riser is supported by a floating buoy, which then connects to a flexible hose for delivering production fluids from the riser to the production facility.

The drilling and maintenance of remote offshore wells is expensive. In an effort to reduce drilling and maintenance expenses, remote offshore wells are often drilled in clusters. A grouping of wells in a clustered subsea arrangement is sometimes referred to as a “subsea wellsite.” A subsea wellsite typically includes producing wells completed for production at one or more “pay zones.”

The grouping of remote subsea wells facilitates the gathering of production fluids into a local production manifold. Fluids from clustered wells are delivered to the manifold through the jumpers. From the manifold, the production fluids may be delivered together to the host production facility through the flowlines and riser. For wellsites that are in deeper waters, the gathering and separating facility is typically a floating production, storage, and offloading vessel (FPSO).

One challenge facing offshore production operations is ensuring the integrity and proper functionality of the components within the SPS. In particular, the SPS includes a number of fluid-filled closed volumes that should be pressure-rated to the conditions encountered during subsea installation and operation. For instance, on a vertical subsea tree (VXT), the cavity between the subsea tree cap and the swab valve is typically filled with an inhibited water-based fluid and/or methanol, which helps to prevent hydrate formation, and is sealed to ambient seawater conditions. Similar fluid-filled closed volumes exist in coupler galleries, in the cavities between closure mechanisms (e.g., valves, plugs, and the like), such as, for example, the dual crown plugs in horizontal subsea trees (HXT), and in hydraulic actuators within downhole control lines connected to downhole valves or intelligent well components.

One concern of pressure buildup within subsea production equipment exists during the production of hot fluids. During this time, heat is transported to the seabed and through the subsea tree and corresponding system of pipes, including the jumpers, flowlines, and riser, for example. This heat transfer causes thermal expansion of the fluid within the aforementioned closed volumes, thus increasing the pressure within such closed volumes. If the fluid is not able to be bled off in some manner, such pressure increases can potentially exceed the pressure ratings (e.g., burst pressure rating and/or rated working pressure rating) of the corresponding subsea production equipment or, at the least, may damage the integrity of the subsea production equipment over time.

In addition, for some subsea production equipment, such as actuators, connectors, and pressure control systems, pressure changes arise not only due to fluid temperature changes, but also due to the mechanical activation of closure mechanisms, which may result in fluid compression. These pressure changes may preclude such equipment from being consistently operated within ideal pressure ranges, thus negatively impacting the integrity and proper functionality of the equipment over time.

### SUMMARY OF THE INVENTION

An embodiment described herein provides a method for managing pressure buildup within a component of subsea production equipment using compressible particles are provided herein. The method includes positioning compressible particles within a fluid-filled closed volume defined within a component of subsea production equipment such that an increase in fluid pressure within the fluid-filled closed volume is attenuated by reversible volumetric contraction of the compressible particles.

Another embodiment described herein provides another method for managing pressure buildup within a component of subsea production equipment using compressible particles. The method includes providing a packing of compressible particles by impregnating the compressible particles into a cross-linked polymer matrix or encapsulating the compressible particles within an elastomeric coating. The method also includes affixing the packing to an interior surface of a fluid-filled closed volume that is defined within a component of subsea production equipment and deploying the subsea production equipment within a subsea environment as part of a subsea production system (SPS). The method further includes increasing the fluid pressure within the fluid-filled closed volume via thermal expansion and/or mechanical straining of the fluid within the fluid-filled closed volume and attenuating the increase in the fluid pressure via reversible volumetric contraction of the compressible particles within the packing.

Another embodiment described herein provides another method for managing pressure buildup within a component of subsea production equipment using compressible particles. The method includes positioning the compressible particles within a containment area that is defined by a filter screen, piston, or diaphragm that enables pressure communication between the compressible particles within the containment area and fluid within a fluid-filled closed volume defined within a component of subsea production equipment. The method also includes deploying the subsea production equipment within a subsea environment as part of an

SPS, increasing the fluid pressure within the fluid-filled closed volume via thermal expansion and/or mechanical straining of the fluid within the fluid-filled closed volume and attenuating the increase in the fluid pressure via reversible volumetric contraction of the compressible particles within the containment area.

These and other features and attributes of the disclosed embodiments of the present techniques and their advantageous applications and/or uses will be apparent from the detailed description that follows.

### BRIEF DESCRIPTION OF THE DRAWINGS

To assist those of ordinary skill in the relevant art in making and using the subject matter described herein, reference is made to the appended drawings, where:

FIG. 1 is a schematic view of an exemplary subsea production system including subsea production equipment with corresponding fluid-filled closed volumes that are pressure-regulated using compressible particles in accordance with the present techniques;

FIG. 2 is a schematic view of an exemplary vertical subsea tree with one or more fluid-filled closed volumes that are pressure-regulated using compressible particles in accordance with the present techniques;

FIG. 3 is a graph showing experimentally-measured carbon volume changes of exemplary compressible particles as a function of fluid pressure in accordance with the present techniques;

FIG. 4 is a graph showing predicted pressure-temperature relations in a methanol-filled closed volume that contains varying quantities of compressible particles at initial conditions of 40° F. and 4,000 pounds per square inch (psi) in accordance with the present techniques;

FIG. 5A is a perspective, cut-away view of an exemplary packing of compressible particles that is affixed to the interior surface of a portion of a component of subsea production equipment that defines a fluid-filled closed volume in accordance with the present techniques;

FIG. 5B is a cross-sectional view of the packing of FIG. 5A in accordance with the present techniques;

FIG. 6A is a perspective, cut-away view of an exemplary slotted filter screen that is used to secure the compressible particles to the interior surface of the portion of the component that defines the fluid-filled closed volume in accordance with the present techniques;

FIG. 6B is a cross-sectional view of the slotted filter screen of FIG. 6A in accordance with the present techniques;

FIG. 7A is a perspective, cut-away view showing an embodiment in which the compressible particles are directly mixed with the fluid within the portion of the component that defines the fluid-filled closed volume in accordance with the present techniques;

FIG. 7B is a cross-sectional view showing the compressible particles mixed with the fluid within the central region of the component in accordance with the present techniques;

FIG. 8 is a cross-sectional view of a diaphragm chamber that is attached to a portion of a component that defines a fluid-filled closed volume, where the diaphragm chamber is used to contain compressible particles in accordance with the present techniques;

FIG. 9 is a cross-sectional view of a piston chamber that is attached to a portion of a component that defines a fluid-filled closed volume, where the piston chamber is used to contain compressible particles in accordance with the present techniques;

FIG. 10A is a cross-sectional view of an exemplary compressible particle that may be utilized in accordance with the present techniques;

FIG. 10B is a cross-sectional view of another exemplary compressible particle that may be utilized in accordance with the present techniques;

FIG. 11 is a process flow diagram of an exemplary method for managing pressure buildup within subsea production equipment using compressible particles in accordance with the present techniques; and

FIG. 12 is a process flow diagram of another exemplary method for managing pressure buildup within subsea production equipment using compressible particles in accordance with the present techniques.

It should be noted that the figures are merely examples of the present techniques and are not intended to impose limitations on the scope of the present techniques. Further, the figures are generally not drawn to scale, but are drafted for purposes of convenience and clarity in illustrating various aspects of the techniques.

### DETAILED DESCRIPTION OF THE PREFERRED EMBODIMENTS

In the following detailed description section, the specific examples of the present techniques are described in connection with preferred embodiments. However, to the extent that the following description is specific to a particular embodiment or a particular use of the present techniques, this is intended to be for exemplary purposes only and simply provides a description of the embodiments. Accordingly, the techniques are not limited to the specific embodiments described below, but rather, include all alternatives, modifications, and equivalents falling within the true spirit and scope of the appended claims.

### Terminology

At the outset, and for ease of reference, certain terms used in this application and their meanings as used in this context are set forth. To the extent a term used herein is not defined below, it should be given the broadest definition those skilled in the art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

As used herein, the singular forms “a,” “an,” and “the” mean one or more when applied to any embodiment described herein. The use of “a,” “an,” and/or “the” does not limit the meaning to a single feature unless such a limit is specifically stated.

The terms “about” and “around” mean a relative amount of a material or characteristic that is sufficient to provide the intended effect. The exact degree of deviation allowable in some cases may depend on the specific context, e.g., ±1%, ±5%, ±10%, ±15%, etc. It should be understood by those of skill in the art that these terms are intended to allow a description of certain features described and claimed without restricting the scope of these features to the precise numerical ranges provided. Accordingly, these terms should be interpreted as indicating that insubstantial or inconsequential modifications or alterations of the subject matter described are considered to be within the scope of the disclosure.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “any” means one, some, or all of a specified entity or group of entities, indiscriminately of the quantity.

The phrase “at least one,” in reference to a list of one or more entities, should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A or B” (or, equivalently, “at least one of A and B,” or, equivalently, “at least one of A and/or B”) may refer, in one embodiment, to at least one, optionally including more than one, A, with no B present (and optionally including entities other than B);

in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase “based on” does not mean “based only on,” unless expressly specified otherwise. In other words, the phrase “based on” means “based only on,” “based at least on,” and/or “based at least in part on.”

As used herein, the terms “example,” exemplary,” and “embodiment,” when used with reference to one or more components, features, structures, or methods according to the present techniques, are intended to convey that the described component, feature, structure, or method is an illustrative, non-exclusive example of components, features, structures, or methods according to the present techniques. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present techniques.

As used herein, the term “fluid” refers to gases and liquids, as well as to combinations of gases and liquids, combinations of gases and solids, combinations of liquids and solids, and combinations of gases, liquids, and solids.

A “hydrocarbon” is an organic compound that primarily includes the elements hydrogen and carbon, although nitrogen, sulfur, oxygen, metals, or any number of other elements may be present in small amounts. As used herein, the term “hydrocarbon” generally refers to components found in raw natural gas and oil.

The term “manifold” refers to an item of subsea production equipment that gathers production fluids from one or more subsea trees and delivers those fluids to a production line, either directly or through a jumper line.

As used herein, the term “production fluids” refers to fluids removed from a subsurface formation, including hydrocarbon fluids removed from an offshore reservoir.

The term “production facility” refers to any facility for receiving production fluids. The production facility may be a ship-shaped vessel located over a subsea wellsite, a floating production, storage, and offloading vessel (FPSO) located over or near a subsea wellsite, a near-shore separation facility, or an onshore separation facility.

As used herein, the term “resiliency” refers to the extent to which a particle is capable of volumetrically contracting in response to pressure increases and then subsequently recovering the lost volume in response to pressure decreases.

The term “subsea production system (SPS)” refers to an assembly of production equipment placed in a marine body. The marine body may be an ocean or a deep, freshwater lake, for example. Similarly, the term “subsea” encompasses both an ocean body and a deep, freshwater lake.

The term “subsea production equipment” refers to any item of equipment placed proximate the bottom of a marine body, such as an ocean floor or seabed, as part of an SPS.

The term “subsea well” refers to a well that has a tree proximate the bottom of a marine body, such as an ocean floor or seabed. Similarly, the term “subsea tree” refers to any collection of valves disposed over a wellhead in a marine body.

The term “substantially,” when used in reference to a quantity or amount of a material, or a specific characteristic thereof, refers to an amount that is sufficient to provide an effect that the material or characteristic was intended to provide. The exact degree of deviation allowable may depend, in some cases, on the specific context.

The terms “riser” and “production riser” refer to any tubular structure or collection of lines for transporting production fluids to a production facility, such as an FPSO.

The term “umbilical” refers to any line that contains a collection of smaller lines. An umbilical may also be referred to as an “umbilical line” or an “umbilical cable.”

Certain embodiments and features are described herein using a set of numerical upper limits and a set of numerical lower limits. It should be appreciated that ranges from any lower limit to any upper limit are contemplated unless otherwise indicated. All numerical values are “about” or “approximately” the indicated value, and account for experimental errors and variations that would be expected by those skilled in the art.

Furthermore, concentrations, dimensions, amounts, and/or other numerical data that are presented in a range format are to be interpreted flexibly to include not only the numerical values explicitly recited as the limits of the range, but also all individual numerical values or sub-ranges encompassed within that range, as if each numerical value and sub-range were explicitly recited. For example, a disclosed numerical range of 1 to 200 should be interpreted to include, not only the explicitly-recited limits of 1 and 200, but also individual values, such as 2, 3, 4, 197, 198, 199, etc., as well as sub-ranges, such as 10 to 50, 20 to 100, etc.

### Overview

As described above, excessive pressure buildup within subsea production equipment is an issue that has to be addressed during offshore production operations. However, to-date, suitable solutions to this issue are still lacking. Accordingly, embodiments described herein provide methods for managing pressure buildup within subsea production equipment using compressible particles. More specifically, the compressible particles described herein provide a materials solution that reduces the magnitude of pressure buildup accompanying thermal expansion and/or mechanical straining of fluids inside closed volumes within subsea production equipment.

The compressible particles described herein, which are formed primarily from carbon, possess a low thermal coefficient of expansion and are capable of continuously compressing or contracting in response to pressure increases. In particular, when a large fluid pressure acts against the boundaries of the compressible particles, the pore spaces of the particles collapse. Such collapse allows the compressible particles to shrink, providing additional volume for the fluid within the closed volume to expand and, thus, reducing the pressure within the closed volume.

According to embodiments described herein, such compressible particles are used to mitigate the pressure buildup within various types of subsea production equipment including methanol-filled, control fluid-filled, dielectric fluid-filled, preservation fluid-filled, and/or water-filled closed volumes, for example. Such closed volumes are found, for example, within subsea trees, manifolds, control systems, and the corresponding pipeline system, including the collection of jumpers, flowlines, and risers (among other components of subsea production equipment). In addition, such compressible particles are used to mitigate the mechanical straining of fluids inside closed volumes that are in fluid communication with a mechanically-actuated closure mechanism (e.g., valve) or other similar device. Such closed volumes may be found, for example, within actuators, connectors, pressure control systems, and other similar components of subsea production equipment.

According to embodiments described herein, the compressible particles may be mixed directly into the fluid within a closed volume, affixed to the interior of the closed volume, or contained within a containment area that is in pressure communication with the fluid within the closed volume. As described further herein, in various embodiments, this includes embedding the compressible particles into an elastomer and/or adhesive system and then adhering (e.g., gluing or curing) the elastomer and/or adhesive system onto the interior surface of the closed volume prior to deployment of the corresponding subsea production equipment within the subsea environment. Additionally or alternatively, in various embodiments, this includes placing the compressible particles within a filtered containment, piston chamber, or diaphragm chamber that is defined by a filter screen, piston, or diaphragm, respectively, that enables pressure communication between the compressible particles within the containment area and the fluid within the closed volume.

In various embodiments, the use of such compressible particles within one or more components of an SPS reduces the risk of mechanical failure of such component(s). For example, the use of the compressible particles within closed volumes that are in fluid communication with one or more closure mechanisms may reduce the risk of the closure mechanism(s) losing their proper sealing function. In addition, in extreme cases, the use of the compressible particles reduces the risk of pressure-induced facture of the component(s).

Moreover, the use of the compressible particles may enable the installation of less-expensive subsea production equipment within the SPS, e.g., subsea production equipment with lower pressure ratings.

### Exemplary Subsea Production System and Corresponding Subsea Production Equipment Utilizing Compressible Particles to Manage Pressure Buildup Therein

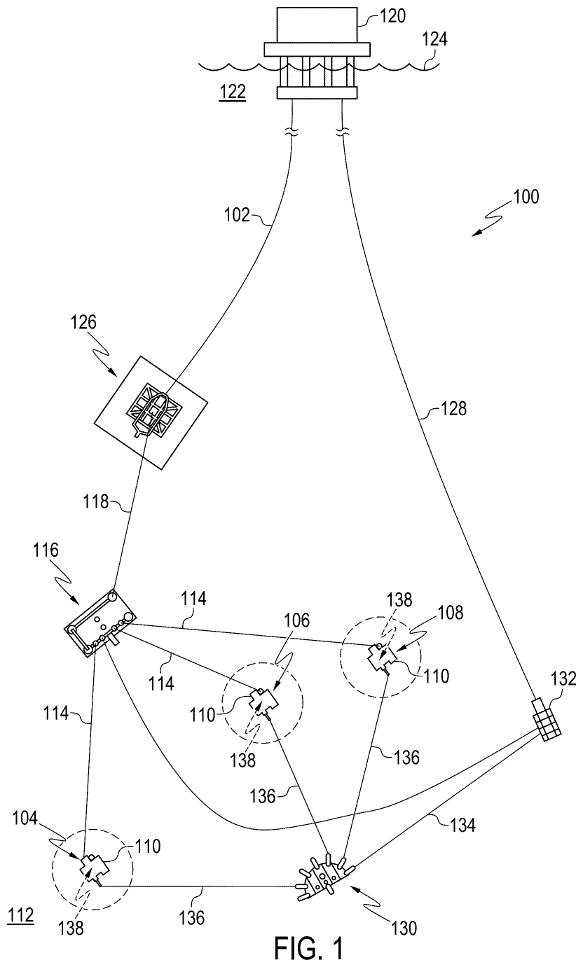

FIG. 1 is a schematic view of an exemplary subsea production system (SPS) 100 including subsea production equipment with corresponding fluid-filled closed volumes that are pressure-regulated using compressible particles in accordance with the present techniques. The SPS 100 is configured to produce hydrocarbons from an offshore reservoir. The exemplary SPS 100 utilizes a single production line, including a production riser 102. Oil, gas, and, typically, water, which are generally referred to as “production fluids,” are produced through the riser 102. In some embodiments, the riser 102 is an 8-inch insulated production line. However, other sizes may be used.

The SPS 100 includes one or more subsea wells. For example, in the arrangement shown in FIG. 1, three subsea wells 104, 106, and 108 are included. In some embodiments, the subsea wells 104, 106, and 108 may include at least one production well and at least one injection well. However, in the arrangement shown in FIG. 1, all three subsea wells 104, 106, and 108 are producers, thereby forming a production cluster.

Each subsea well 104, 106, and 108 includes a subsea tree 110 located on a marine floor 112, e.g., an ocean floor or seabed. Each subsea tree 110 delivers production fluids to a jumper 114. The jumpers 114 then deliver the production fluids to a manifold 116, which is configured to comingle the production fluids and export the production fluids from the wellsite through a subsea flowline 118 and the riser 102. Together, the flowline 118 and the riser 102 provide a single production line.

The riser 102 ties back to a production facility 120. The production facility 120, sometimes referred to as a “host facility” or a “gathering facility,” is any facility where production fluids are collected. The production facility may be, for example, a ship-shaped vessel capable of self-propulsion in a marine body 122, e.g., the ocean, sea, lake or body of water, having a marine surface 124 and the marine floor 112. The production facility may alternatively be fixed to land and reside near shore or immediately onshore. However, for the exemplary SPS 100 shown in FIG. 1, the production facility 120 is a floating production, storage, and offloading vessel (FPSO) moored in the marine body 122.

As shown in FIG. 1, the SPS 100 may include a production sled 126 for connecting the flowline 118 to the riser 102. In addition, the SPS 100 includes a utility umbilical 128, which is an integrated electrical/hydraulic control line. In particular, the utility umbilical 128 typically includes conductive wires for providing power to subsea production equipment. A control line within the utility umbilical 128 may carry hydraulic fluid used for controlling items of subsea production equipment, such as a subsea distribution unit (SDU) 130, the manifold 116, and the subsea trees 110 connected to the subsea wells 104, 106, and 108. Such control lines allow for the actuation of closure mechanisms and other subsea components from the surface.

The utility umbilical 128 connects subsea to an umbilical termination assembly (UTA) 132. From the UTA 132, an umbilical line 134 is provided and connects to the SDU 130. From the SDU 130, flying leads 136 connect to the individual subsea wells 104, 106, and 108.

As described herein, various items of subsea production equipment within the SPS 100 include fluid-filled closed volumes that has to be pressure-rated to the conditions encountered during subsea installation and operation. For instance, in various embodiments, the subsea trees 110 are vertical subsea trees (VXTs). In such VXTs, the cavity between the subsea tree cap (not shown) and the swab valve (not shown) is typically filled with an inhibited water-based fluid and/or methanol and is sealed to ambient seawater conditions, forming a fluid-filled closed volume. Additionally or alternatively, the subsea trees 110 may include one or more other fluid-filled closed volumes. For example, for embodiments in which the subsea trees 110 are horizontal subsea trees (HXTs), the subsea trees 110 may include dual crown plugs (not shown) that form fluid-filled closed volumes in cavities between the plugs and corresponding valves.

Furthermore, other subsea production equipment within the SPS 100 may include fluid-filled closed volumes, such as inside coupler galleries, in the cavities between closure mechanisms (e.g., between plugs and corresponding valves), and in hydraulic actuators within downhole control lines connected to downhole valves or intelligent well components. During production operations, hot production fluids flow through the subsea production equipment within the SPS 100, including through the subsea trees 110, causing the thermal expansion of fluids that are trapped within such fluid-filled closed volumes. This, in turn, causes the pressure within such closed volumes to increase. In some cases, such pressure increases may exceed the pressure ratings (e.g., burst pressure rating and/or rated working pressure rating) of the corresponding subsea production equipment or, at the least, may damage 30 the integrity of the subsea production equipment over time. Moreover, in the case of fluid-filled closed volumes that are in fluid communication with a mechanically-actuated closure mechanism or other similar device, such as closed volumes found within, for example, actuators, connectors, and/or pressure control systems, the mechanical straining of the fluids within such closed volumes may also increase the pressure within the closed volumes such that the pressure exceeds the pressure ratings (and/or damages the subsea production equipment over time).

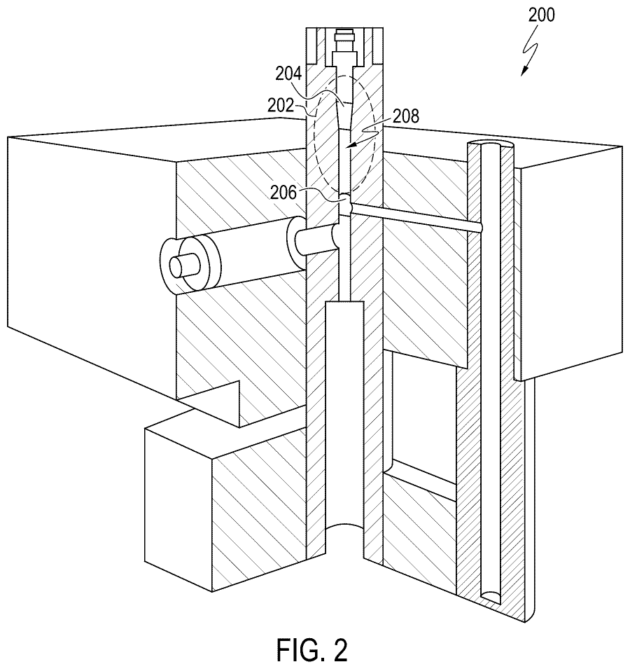

Therefore, according to embodiments described herein, compressible particles 138 are placed into the fluid-filled closed volumes defined by one or more components of subsea production equipment to mitigate pressure buildup due to thermal expansion and/or mechanical straining. Such components may include, but are not limited to, the upper tree cap of the subsea trec, the cavities within the manifold, the coupler galleries between the subsea tree and the tubing hangers, and the downhole lines. As an example, according to the exemplary embodiment shown in FIG. 1, the compressible particles 138 are positioned within one or more fluid-filled closed volumes within the subsea trees 110, as described further with respect to FIG. 2. As another example, the compressible particles 138 may be affixed to an interior surface (e.g., inner wall or inner diameter) of one or more pipes within the pipeline system of the SPS 100, e.g., within any of the jumpers, flowlines, and/or risers. As another example, the compressible particles 138 may be positioned within any fluid-filled closed volumes that are formed between two closure mechanisms (e.g., valves or other similar components), where the mechanical actuation of the closure mechanisms is likely to cause pressure fluctuations within the corresponding closed volume. Moreover, the compressible particles 138 may also be positioned within any other suitable components of the SPS 100, depending on the details of the particular implementation.

As described further herein, in some embodiments, the compressible particles 138 are directly mixed into the fluid that is contained within the fluid-filled closed volumes. Additionally or alternatively, in some embodiments, the compressible particles 138 are placed into an elastomeric coating that lines the interior of the fluid-filled closed volumes. For example, in such embodiments, the compressible particles may be embedded into elastomers and/or adhesive systems, which are then glued, cured, or otherwise affixed onto the interior surfaces of the fluid-filled closed volumes prior to deployment of the corresponding subsea equipment within the subsea environment. Additionally or alternatively, in some embodiments, the compressible particles 138 are placed into containment areas that are defined by filter screens, diaphragms, pistons, or other similar mechanisms within the fluid-filled closed volumes.

The schematic view of FIG. 1 is not intended to indicate that the SPS 100 is to include all of the components shown in FIG. 1, or that the SPS 100 is limited to only the components shown in FIG. 1. Rather, any number of components may be omitted from the SPS 100 or added to the SPS 100, depending on the details of the specific implementation.

In various embodiments, the compressible particles described herein serve one or more other purposes in addition to alleviating thermal and mechanical pressure buildup within fluid-filled closed volumes. As an example, the compressible particles may be used to increase the operability of certain components of subsea production equipment. In particular, in some cases, the strong differential pressure across closure mechanisms during actuation makes it difficult for closure mechanisms to open. Thus, the compressible particles may be used to increase the operability of the closure mechanisms by reducing the pressure fluctuations in the closed volume. For example, in some embodiments, the compressible particles are positioned within accumulators (or other similar components) to confine pressure swings to within a desired range and/or to store clastic potential energy, maintaining a positive pressure difference across closure mechanisms, where required. This may also prevent the closure mechanisms from leaking as a result of large pressure swings. As another example, the compressible particles may be used to reduce the negative effects of water hammer events by, for example, enabling closure mechanisms to be opened/closed in a more controlled manner.

FIG. 2 is a schematic view of an exemplary vertical subsea tree 200 with one or more fluid-filled closed volumes that are pressure-regulated using compressible particles in accordance with the present techniques. In particular, the VXT 200 includes a fluid-filled closed volume 202 that is below a trec cap 204 and above a swab valve 206. In various embodiments, this fluid-filled closed volume 202 is filled with an inhibited water-based fluid and/or methanol. For example, the methanol may be included to help prevent hydrate formation. Moreover, the fluid-filled closed volume 202 is sealed to ambient seawater conditions (where the term “seawater” is inclusive of freshwater within deep lakes for embodiments in which the marine body is not an occan).

In some embodiments, compressible particles 208 are directly mixed within the inhibited water-based fluid and/or methanol within the fluid-filled closed volume 202. In other embodiments, the compressible particles 208 are embedded within elastomers and/or adhesive systems, as described further herein. The elastomers and/or adhesive systems including the compressible particles 208 are then glued, cured, or otherwise affixed to one or more interior surfaces of the closed volume prior to deploying the VXT 200 within the subsea environment. Furthermore, in other embodiments, the compressible particles 208 are deployed into the fluid-filled closed volume (either via direct mixing, elastomeric coating, or other suitable means) during replacement of one or more components of the VXT 200, including the tree cap 204. In some embodiments, the replacement of such components may additionally or alternatively enable the compressible particles 208 to be replenished and/or replaced at some point during the lifetime of the corresponding subsea well.

The schematic view of FIG. 2 is not intended to indicate that the VXT 200 is to include all of the components shown in FIG. 2, or that the VXT 200 is limited to only the components shown in FIG. 2. Rather, any number of components may be omitted from the VXT 200 or added to the VXT 200, depending on the details of the specific implementation. Moreover, it is to be understood that embodiments described herein are not limited to subsea wells including vertical subsea trees, as horizontal subsea trees (HXTs) may also be utilized. Morcover, the one or more subsea trees within the corresponding SPS, e.g., including the VXT 200, may include any number of additional fluid-filled closed volumes that may similarly benefit from the use of compressible particles for mitigating pressure buildup therein. As an example, the cavities surrounding dual crown plugs in HXTs may benefit from the use of such compressible particles. Moreover, any fluid-filled cavities disposed between two closure mechanisms would also benefit from the use of the compressible particles. Furthermore, as described herein, other components within the corresponding SPS may also benefit from the use of such compressible particles, and embodiments described herein are not limited to the use of the compressible particles within subsea trees.

### Exemplary Properties of Compressible Particles and Means of Deploying Compressible Particles within Components of SPS

The compressible particles described herein are designed with a closed porosity structure that is sealed to fluid ingress. This structure enables the particles to efficiently contract or compress in response to increased fluid pressure. Specifically, upon increasing the pressure on the compressible particles, the closed pores collapse, and the compressible particles shrink, which provides additional volume to the surrounding fluid.

According to embodiments described herein, the compressible particles are capable of volumetrically contracting or compressing to a greater extent than the fluid within the closed volumes for which such particles are utilized. In various embodiments, the compressible particles are designed to contract by around 10% to around 30% of their initial unpressurized (or unstressed) volume as the fluid pressure surrounding the particles is increased from around 15pounds per square inch (psi) (atmospheric pressure) to around 10,000 psi. Moreover, in various embodiments, the compressible particles demonstrate the majority of their shrinkage between around 3,000 psi to around 10,000 psi, a range that is relevant to subsea production equipment. Furthermore, in various embodiments, the compressible particles contract continuously (or substantially continuously) within the relevant pressure ranges, enabling the pressure buildup to be continuously and effectively mitigated.

Upon reducing the fluid pressure, the compressible particles rebound back to their original shape (or to substantially their original shape). In subsea production equipment, this resiliency allows the compressible particles to repeatedly shrink and expand without loss in performance when responding to thermal cycles. Moreover, this resiliency enables the compressible particles to be used in accumulators and fluid compensation systems to reduce pressure fluctuations and/or to maintain positive pressure across components.

Furthermore, in various embodiments, the compressible particles have a lower (or comparable) coefficient of thermal expansion than the fluid within the closed volumes for which such particles are utilized. This ensures that the volumetric contraction of the compressible particles is not negated by simultaneous thermal expansion of the particles.

In various embodiments, the compressible particles can be manufactured to a desired particle size distribution, ranging in median particle diameter from around 10 micrometers (or microns (μm)) to around 1300 μm. However, it should be noted that the extent to which the compressible particles can volumetrically contract is correlated to their size, with larger particles being capable of volumetrically contracting to a greater extent than smaller particles. Moreover, additional technical details of a suitable type of compressible particle are described in U.S. Pat. No. 9,458,703, which is incorporated herein by reference in its entirety.

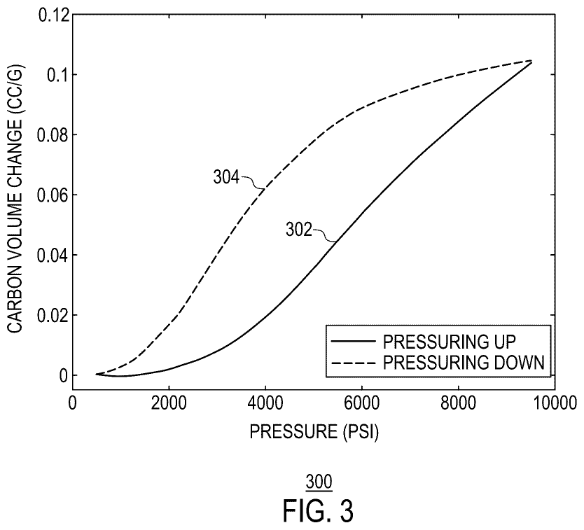

FIG. 3 is a graph 300 showing experimentally-measured carbon volume changes (in cubic centimeters per gram (cc/g)) of exemplary compressible particles as a function of fluid pressure (in psi) in accordance with the present techniques. The exemplary compressible particles are graphitic, porous carbon particles manufactured by Superior Graphite Co. of Chicago, Illinois, which have a median particle diameter of around 400 μm and a density of 1.49 grams per cubic centimeter (g/cc). Moreover, the density of the particles was measured using Helium pycnometry such that the particles' volume used for the density measurement included intragranular pores but neglected gas-accessible intergranular pores.

The graph 300 demonstrates the path-dependent constitutive behavior of the compressible particles. In particular, the trajectories for the pressure vs. strain curves differ depending on whether the pressure is increased, as indicated by curve 302, or decreased, as indicated by curve 304.

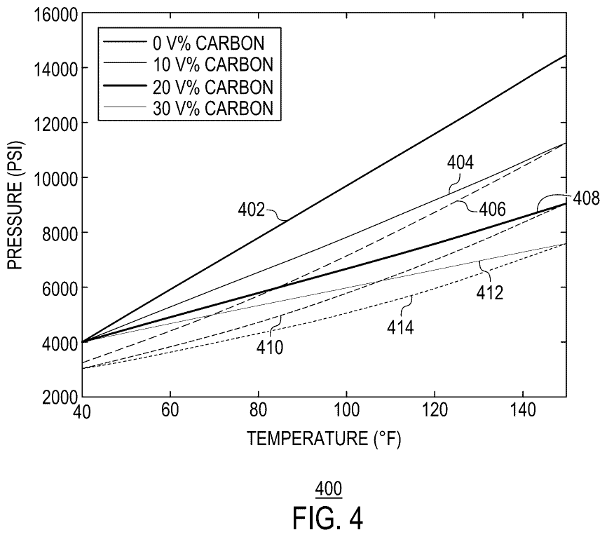

FIG. 4 is a graph 400 showing predicted pressure-temperature relations in a methanol-filled closed volume that contains varying quantities of compressible particles at initial conditions of 40° F. and 4,000 psi in accordance with the present techniques. In the graph 400, the varying compressible particle loadings are listed as volume fractions. In particular, a first curve 402 shows the pressure-temperature relation in the methanol-filled closed volume with 0 volume percent (v %) compressible particles; second and third curves 404 and 406 show the pressure-temperature relation in the methanol-filled closed volume with 10 v % compressible particles; fourth and fifth curves 408 and 410 show the pressure-temperature relation in the methanol-filled closed volume with 20 v % compressible particles; and sixth and seventh curves 412 and 414 show the pressure-temperature relation in the methanol-filled closed volume with 30 v % compressible particles. Moreover, the thick, solid curves 402, 404, 408, and 412 plot the pressure-temperature relation when heating the volume from 40° F., while the thin, dashed curves 406, 410, and 414 plot the pressure-temperature relation when cooling from 150° F. Overall, the graph 400 demonstrates the significant drop in pressure buildup that is expected when compressible particles are incorporated into fluid-filled closed volumes within components of subsea production equipment.

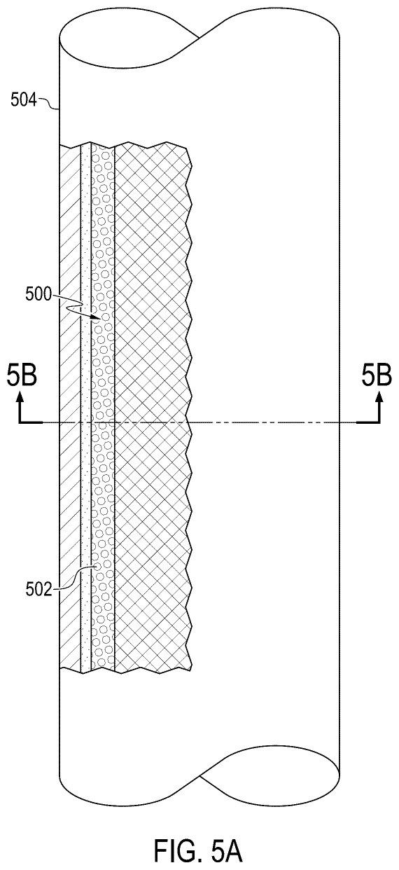

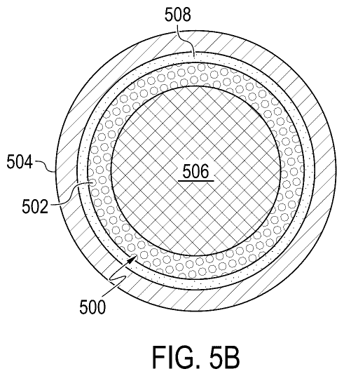

FIG. 5A is a perspective, cut-away view of an exemplary packing 500 of compressible particles 502 that is affixed to an interior surface (e.g., inner wall or inner diameter) of a portion of a component 504 of subsea production equipment that defines a fluid-filled closed volume in accordance with the present techniques. In various embodiments, the component 504 may be an internal or external component of a subsea tree, control system, manifold, jumper, flowline, riser, or any other suitable type of subsea production equipment. Moreover, the component 504 is shown as an elongated cylindrical body in FIG. 5A. However, this is for case of illustration only, as the component 504 may take any suitable regular or irregular, cylindrical or non-cylindrical shape or form, depending on the type of component and its placement within the corresponding SPS. Furthermore, the component 504 may be fabricated from any suitable material(s) having rated working pressure rating(s) and burst pressure rating(s) that are suitable for deployment within a particular subsea environment. For example, in some embodiments, the component 504 is fabricated, at least in part, from a steel material.

In various embodiments, the packing 500 defines a matrix of compressible particles 502 that are held together by means of a cross-linked polymer or other binder, forming a sheet. In the exemplary embodiment shown in FIG. 5A, the packing 500 has been adhered to the inner diameter of the component 504.

In some embodiments, a foam or rubber composite houses the compressible particles 502 by impregnating them into a cross-linked polymer matrix. Alternatively, the binder is silicone, nitrile butadiene rubber (NBR), fluoroelastomer (FKM), or hydrogenated nitrile butadiene rubber (HNBR), providing a compressible solid filler. Alternatively still, a thermoset or thermoplastic (or soft plastic) material is used as the binder.

Compared to the compressible particles 502, the polymer is soft and less compressible, allowing it to effectively transmit stress onto the compressible particles 502 collectively. This allows the porous matrix of the compressible particles 502 to compress, providing additional volume for the fluid within the component 504 to move into as it thermally or mechanically expands (or is otherwise strained).

The packing 500 may be formed as a thick, mechanically robust sheet of material. The packing 500 may be, for example, one to three centimeters in thickness. In some embodiments, the compressible particles 502 include an electro-thermally treated calcined petroleum coke material. The coke material may have small pores that are closed to fluid ingress, which allows them to compress when the fluid pressure surrounding the compressible particles 502 is increased. In addition, the compressible particles 502 are durable under repeated, cyclic loading and sustained loading at high pressure, providing reversible volumetric contraction for the fluid and particle mixture.

In various embodiments, the compressible particles 502 define a carbonaceous particulate material characterized by having a reversible volumetric contraction of around 10% to around 30%, or in some cases, around 13% to around 18%, when the pressure surrounding the particles 502 is increased around 15 psi to around 10,000 psi. Moreover, in various embodiments, the volumetric contraction of the particles 502 is greatest when the pressure surrounding the particles 502 ranges from around 3,000 psi to around 10,000 psi. Within this pressure range, the particles 502 contract by more than 3% of their initial volume, where the initial volume is the volume of the particles 502 at a hydrostatic pressure of 3,000 psi.

FIG. 5B is a cross-sectional view of the packing 500 of FIG. 5A, taken across Line 5B-5B in accordance with the present techniques. In this view, it can be seen that the packing 500 has a generally cylindrical profile in the exemplary embodiment of FIG. 5A. Moreover, the packing 500 is adhered to the interior surface of the component 504 such that the fluid 506 within the central region of the component 504 contacts the packing 500.

In the exemplary embodiment shown in FIG. 5A, the packing 500 including the compressible particles 502 is adhesively affixed (or adhered) to the interior surface of the component 504 using any suitable adhesive substance 508. For example, the compressible particles 502 may be glued, cured, or otherwise adhered to the interior surface of the component 504. In some embodiments, this is accomplished using the same cross-linking polymer or binder that secures the compressible particles 502 themselves together. Additionally or alternatively, in some embodiments, the packing 500 is mechanically and/or frictionally affixed to the interior surface of the component 504 in any suitable manner.

According to the exemplary embodiment shown in FIGS. 5A and 5B, the packing 500 is adhered circumferentially around the entire inner diameter of the component 504. However, in other embodiments, the packing of compressible particles may be in the form of clongated rods that are adhesively secured to the inner diameter of the component 504.

Moreover, in other embodiments, the packing of compressible particles is in the form of any suitable type of elastomeric coating that is adhered to the interior surface of the component 504. In various embodiments, such elastomeric coating is an elastomeric sleeve that encapsulates the compressible particles. In such embodiments, the elastomeric sleeve may be fabricated from any elastomeric material, such as a polymer or polymer composite. As an example, the elastomeric sleeve may be fabricated from a relatively stiff polymeric material. Suitable polymeric materials may include, for example, neoprene, polyurethane rubber, vinyl, nitrile rubber, butyl rubber, silicone rubber, or combinations thereof. Moreover, as another example, the elastomeric sleeve may be fabricated from a compliant polymeric material having micro-pores that permit an ingress of the fluid from the corresponding fluid-filled closed volume.

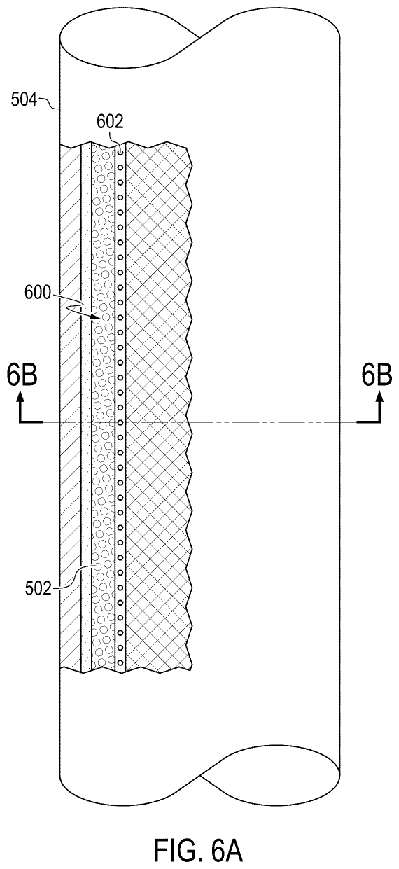

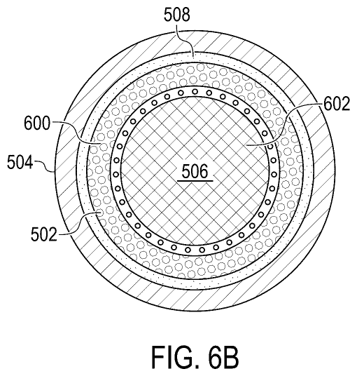

FIG. 6A is a perspective, cut-away view of an exemplary slotted filter screen 600 that is used to secure the compressible particles 502 to the interior surface of the portion of the component 504 that defines the fluid-filled closed volume in accordance with the present techniques. Like numbered items are as described with respect to FIGS. 5A and 5B. In the exemplary embodiment shown in FIG. 6A, the slotted filter screen provides a more rigid medium for deploying the compressible particles 502 within the component 504, as compared to the packing 500 of FIGS. 5A and 5B. In this embodiment, the compressible particles 502 need not be bound together into a cross-linked polymer matrix; instead, the compressible particles 502 are tightly held in place along the interior surface of the component 504 by affixing the slotted filter screen 600 to such interior surface.

The slotted filter screen 600 is designed to be filled with compressible particles 502 and fitted to the interior surface (e.g., inner wall or inner diameter) of the component 504. The slotted filter screen 600 includes a number of dedicated slots 602 that permit fluid and pressure communication between the compressible particles and the fluid within the central region of the component 504. The gap size of the slots 602 in the slotted filter screen 600 may range in size from around 10 μm to around 100 μm, for example, depending on the specific particle size distribution. At the same time, the particle size distribution for the compressible particles 502 may range between around 10 μm and around 1300 μm (in dry state), for example. In various embodiments, the median diameter for the compressible particles 502 is in a range between around 300 μm and around 500 μm, for example. In some embodiments, about 10% of the compressible particles 502 have a diameter that is over around 700 μm, or over around 800 μm. It is understood that the slots 602 should be smaller than the smallest of the diameters of the compressible particles 502 to ensure that the compressible particles 502 remain within the containment area defined between the interior surface of the component 504 and the barrier formed by the slotted filter screen 600.

In the exemplary embodiment shown in FIG. 6A, the slotted filter screen 600 is substantially rigid. This protects the integrity of the compressible particles 502 residing within the containment area. In addition, in various embodiments, a sufficient number of compressed particles 502 are used to fill the slotted filter screen 600. As the fluid within the component 504 expands due to thermal and/or mechanical pressure buildup, the compressible particles 502 begin to collapse, thereby absorbing the increased pressure and reducing the likelihood of the component 504 fracturing during production operations.

FIG. 6B is a cross-sectional view of the slotted filter screen 600 of FIG. 6A, taken across Line 6B-6B in accordance with the present techniques. In this view, it can be seen that the slotted filter screen 600 has a generally cylindrical profile in the exemplary embodiment of FIG. 6A. Moreover, the slotted filter screen 600 is adhered to the interior surface of the component 504 such that the fluid 506 within the central region of the component 504 contacts the slotted filter screen 600.

Moreover, in alternative embodiments, the filter screen may be provided as a wound filter screen. In such embodiments, the filter screen may be similar to a known sand screen and may be fabricated from either steel (or any corrosion-resistant alloy) or ceramic. For example, in such embodiments, the filter screen may be fabricated from metal wire that is wound around and supported by elongated vertical ribs (not visible), with micro-slots preserved between the wire to enable fluid and pressure communication into the containment area. Furthermore, it is to be understood that the filter screen described herein is not limited to a slotted filter screen or a wound filter screen but, rather, may include any other suitable type of filter screen, depending on the details of the specific implementation.

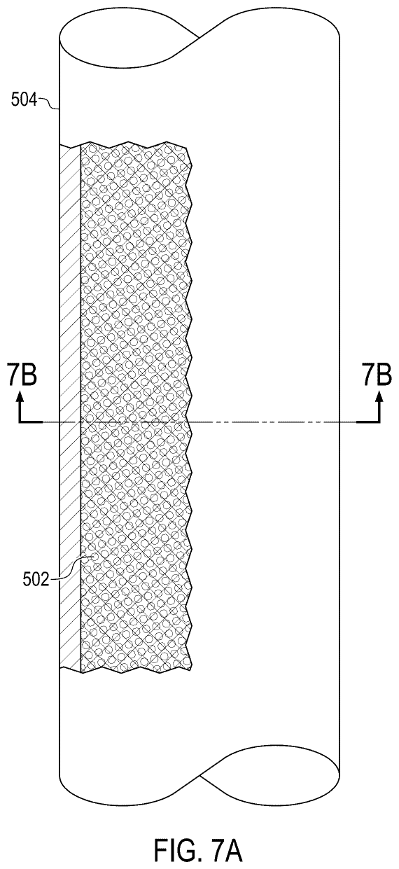

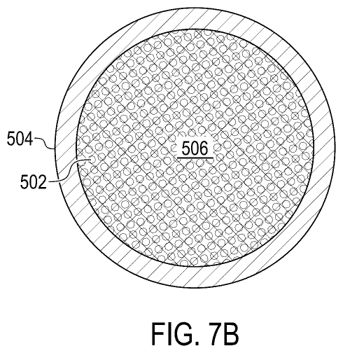

FIG. 7A is a perspective, cut-away view showing an embodiment in which the compressible particles 502 are directly mixed with the fluid 506 within the portion of the component 504 that defines the fluid-filled closed volume in accordance with the present techniques. Like numbered items are as described with respect to FIGS. 5A and 5B. In addition, FIG. 7B is a cross-sectional view, taken across Line 6B-6B, showing the compressible particles 502 mixed with the fluid 506 within the central region of the component 504 in accordance with the present techniques.

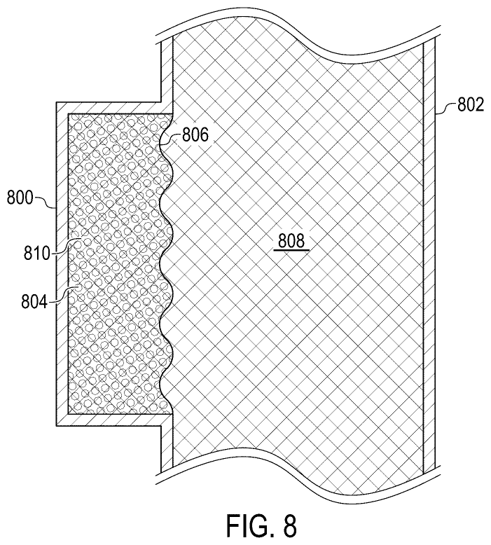

FIG. 8 is a cross-sectional view of a diaphragm chamber 800 that is attached to a portion of a component 802 that defines a fluid-filled closed volume, where the diaphragm chamber 800 is used to contain compressible particles 804 in accordance with the present techniques. In various embodiments, the component 802 may be an internal or external component of a subsea tree, control system, manifold, jumper, flowline, riser, or any other suitable type of subsea production equipment including one or more fluid-filled closed volumes. As a non-limiting example, the portion of the component 802 shown in FIG. 8 may be formed between one or more mechanically-actuated closure mechanisms (not shown). Furthermore, the component 504 may take any suitable shape or form, depending on the type of component and its placement within the corresponding SPS, and may be fabricated from any suitable material(s) having rated working pressure rating(s) and burst pressure rating(s) that are suitable for deployment within a particular subsea environment.

According to the embodiment shown in FIG. 8, the diaphragm chamber 800 includes a diaphragm 806 that forms a hermetic seal between the interior region of the component 802, which contains a fluid 808, and the interior region of the diaphragm chamber 800, which contains the compressible particles 804 described herein. In various embodiments, the diaphragm 806 is designed to compress inward (i.e., in the direction of the compressible particles 804) as the pressure of the fluid 808 within the interior region of the component 802 increases. This, in turn, applies increased pressure to the compressible particles 804, which volumetrically contract in response. In this manner, the increase in fluid pressure within the fluid-filled closed volume is attenuated by the reversible volumetric contraction of the compressible particles 804, as described herein. Furthermore, in some embodiments, the interior region of the diaphragm chamber 800 also contains any suitable type of fluid 810 that is capable of assisting in transmitting the increased fluid pressure to the compressible particles 804.

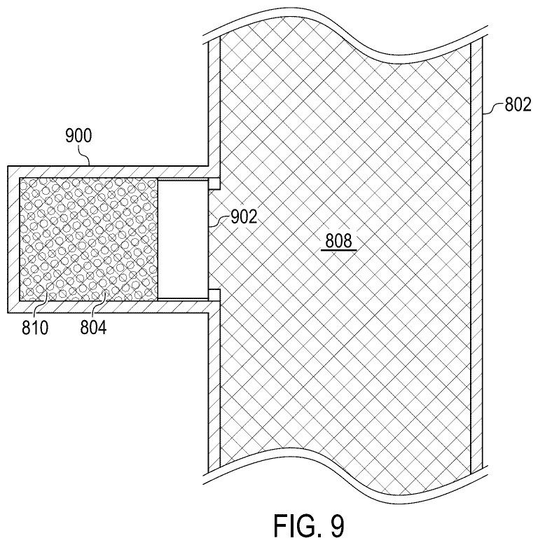

FIG. 9 is a cross-sectional view of a piston chamber 900 that is attached to the portion of the component 802 that defines the fluid-filled closed volume, where the piston chamber 900 is used to contain the compressible particles 804 in accordance with the present techniques. Like numbered items are as described with respect to FIG. 8. In various embodiments, the piston chamber 900 includes a piston 902 that defines a barrier between the interior region of the component 802, which contains the fluid 808, and the interior region of the piston chamber 900, which contains the compressible particles 804 and (optionally) the additional fluid 810 that helps to transmit the increased fluid pressure to the compressible particles 804. In various embodiments, the piston 902 is designed to move (or slide) inward (i.e., in the direction of the compressible particles 804) as the pressure of the fluid 808 within the interior region of the component 802 increases. This, in turn, applies increased pressure to the compressible particles 804, which volumetrically contract in response. In this manner, the increase in fluid pressure within the fluid-filled closed volume is attenuated by the reversible volumetric contraction of the compressible particles 804, as described herein. Moreover, when the pressure of the fluid 808 within the interior region of the component 802 subsequently decreases, the volumetric expansion of the compressible particles 804 back to their original volume (or to substantially their original volume) causes the piston 902 to return to its original position in preparation for the next pressurizing event.

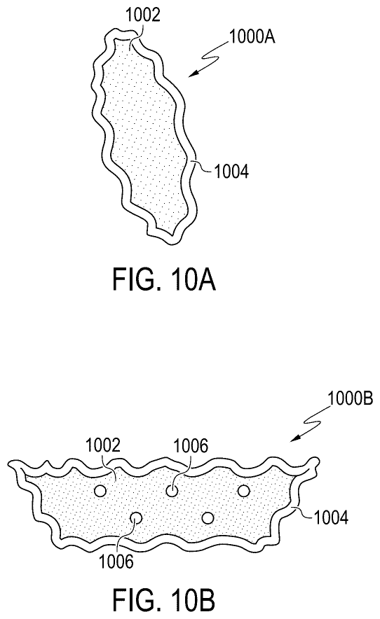

FIG. 10A is a cross-sectional view of an exemplary compressible particle 1000A that may be utilized in accordance with the present techniques. According to the exemplary embodiment shown in FIG. 10A, the compressible particle 1000A has a core 1002 that is angular in shape. In various embodiments, the core 1002 is fabricated from a carbon material. Moreover, the core 1002 is encapsulated within a shell 1004. The shell 1004 may be either an elastomeric material or a foam material, for example.

In some embodiments, the core 1002 is formed from a heat-treated petroleum coke material. In such embodiments, the starting material may be a material that is commercially known as “Calcined Petroleum Coke-Medium High Sulfur.” In some designs, the maximum sulfur content of the starting material may be as high as 8%. The starting material may be heat-treated in a fluidized bed furnace, such as that shown and described in U.S. Pat. No. 4,160,813, which is incorporated herein by reference in its entirety. In such embodiments, the resulting compressible particle 1000A is a carbonaceous particulate material having a substantially reduced sulfur content and a reversible volumetric expansion/contraction in a fluid media of around 10% to around 30% for pressures of around 15 psi to around 10,000 psi. This means that the resulting compressible particle 1000A can be repeatedly subjected to pressures between 15 25 psi and 10,000 psi and still “rebound” to its original volume.

In the arrangement of FIG. 10A, the compressible particle 1000A is highly angular in shape. However, in alternative embodiments, the compressible particle 1000A may be more spherical or ovoid in shape.

FIG. 10B is a cross-sectional view of another exemplary compressible particle 1000B that may be utilized in accordance with the present techniques. In this embodiment, the core 1002 contains a number of small holes 1006. The holes 1006 remain dry (or substantially dry) during pressurization of the compressible particle 1000B and serve to increase the porosity of the compressible particle 1000C, as well as the extent to which the compressible particle 1000C can volumetrically contract. In addition, increasing the number of holes 1006 further increase the extent to which the compressible particle 1000C can volumetrically contract.

As may be appreciated, the compressible particles described herein may have various regular or irregular shapes and may include gaps or holes that are sealed from external fluids. As an example, the compressible particles may be shaped similar to coarse sand or have different irregular polygonal shapes.

In some embodiments, the compressible particles are fabricated from a compressive carbon, such as mesocarbon micro-beads or graphite. Alternatively, the compressible particles may be fabricated from a composite of polymer and graphite that is formed into beads. The graphite material may include graphite carbons. Such materials are available from Superior Graphite Co. of Chicago, Illinois. Alternatively, graphene beads having a high porosity may be used. Pore channels within the beads may optionally be coated with natural rubber or a polymer or pseudo-polymer serving as a synthetic rubber.

In some embodiments, flexible compressible beads formed from a polymeric material are used. For example, a co-polymer of methylmethacrylate and acrylonitrile may be used. Styrofoam or polystyrene may also be used alone or in combination with this co-polymer. In other embodiments, a terpolymer of methylmethacrylate, acrylonitrile and dichloroethane is used. The dichloroethane may be a vinylidene dichloride.

In various embodiments, the compressible particles contract by around 10% to around 30% of their initial unpressurized (or unstressed) volume when acted upon by a hydrostatic fluid pressure that increases from around 15 psi (atmospheric pressure) to around 10,000 psi. As a more specific example, in some embodiments, the compressible particles contract by 15% to 22% when acted upon by a hydrostatic fluid pressure that increases from 15 psi (atmospheric pressure) to 10,000 psi.

In various embodiments, cach compressible particle has a resiliency of between 80% and 120%. As a more specific example, in some embodiments, each compressible particle has a resiliency of between 87% and 117%.

Moreover, those skilled in the art will appreciate that the properties and characteristics of the compressible particles described herein may vary based on the details of the particular implementation. In some embodiments, this variability may be utilized to customize one or more properties of the compressible particles, such as, in particular, the extent to which such particles can volumetrically contract, based on the expected pressures (and/or other conditions) to be encountered within the subsea environment. Furthermore, it is to be understood that the properties and characteristics of the compressible particles may change to some degree over time in response to the repeated contraction and expansion of the particles.

### Methods for Managing Pressure Buildup within Subsea Production Equipment Using Compressible Particles

As described herein, various types of subsea production equipment include components with fluid-filled closed volumes. Such subsea production equipment may include, but is not limited to, subsea trees, control systems, manifolds, and/or pipeline systems that deployed within a subsea environment as part of an SPS. Moreover, during operation of the SPS (e.g., to produce hydrocarbon fluids from one or more corresponding subsea wells), such fluid-filled closed volumes often experience thermal and/or mechanical pressure buildup, which can negatively impact the integrity and/or functionality of the corresponding subsea production equipment. Therefore, embodiments described herein provide methods for attenuating such pressure buildup using compressible particles that are positioned within such fluid-filled closed volumes. In particular, in some embodiments, the compressible particles are positioned within the closed volumes by directly mixing the compressible particles with the fluid within the closed volumes. Additionally or alternatively, in some embodiments, the compressible particles are positioned within the closed volumes by mechanically, frictionally, and/or adhesively affixing packings of the compressible particles to one or more interior surfaces of the close volumes. Additionally or alternatively, in some embodiments, the compressible particles are positioned within the closed volumes by placing the compressible particles within containment areas that are defined by filter screens, pistons, or diaphragms that enable pressure communication between the compressible particles within the containment areas and the fluid within the closed volumes.

In various embodiments, the reversible volumetric contraction of the compressible particles is within a range between 10% and 30% of an initial unpressurized volume of the compressible particles when the fluid pressure within the fluid-filled closed volume is in a range between 15 psi and 10,000 psi. In various embodiments, the compressible particles are formed, at least in part, from calcined petroleum coke and sulfur. In various embodiments, cach compressible particle has a diameter that is in a range between around 10 μm and around 1300 μm (in dry state). Moreover, in various embodiments, the compressible particles contract by 10% to 30% of their initial unpressurized volume when increasing the fluid pressure within the fluid-filled closed volume from 15 psi to 10,000 psi.

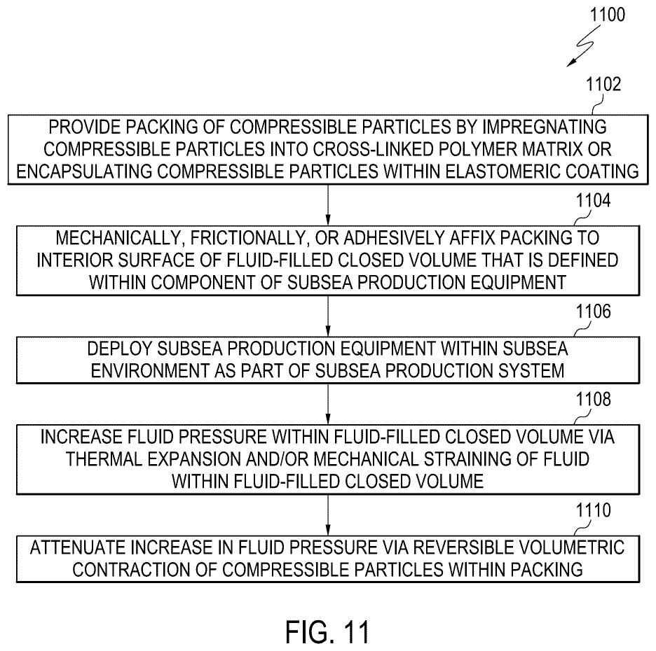

FIG. 11 is a process flow diagram of an exemplary method 1100 for managing pressure buildup within subsea production equipment using compressible particles in accordance with the present techniques. The method 1100 begins at block 1102, at which a packing of compressible particles is provided by impregnating the compressible particles into a cross-linked polymer matrix or encapsulating the compressible particles within an elastomeric coating. At block 1104, the packing is mechanically, frictionally, and/or adhesively affixed to the interior surface of a fluid-filled closed volume that is defined within a component of subsea production equipment. At block 1106, the subsea production equipment is deployed within a subsea environment as part of an SPS.

At block 1108, the fluid pressure within the fluid-filled closed volume is increased via thermal expansion and/or mechanical straining of the fluid within the fluid-filled closed volume. In some embodiments, this includes mechanically actuating one or more closure mechanisms that form one or more ends of the fluid-filled closed volume, resulting in mechanical straining of the fluid. Additionally or alternatively, this includes producing production fluids from one or more subsea wells corresponding to the subsea production equipment, where heat transfer between the production fluids and the fluid within the fluid-filled closed volume results in the thermal expansion of the fluid. Moreover, at block 1110, the increase in fluid pressure is attenuated via reversible volumetric contraction of the compressible particles within the packing.

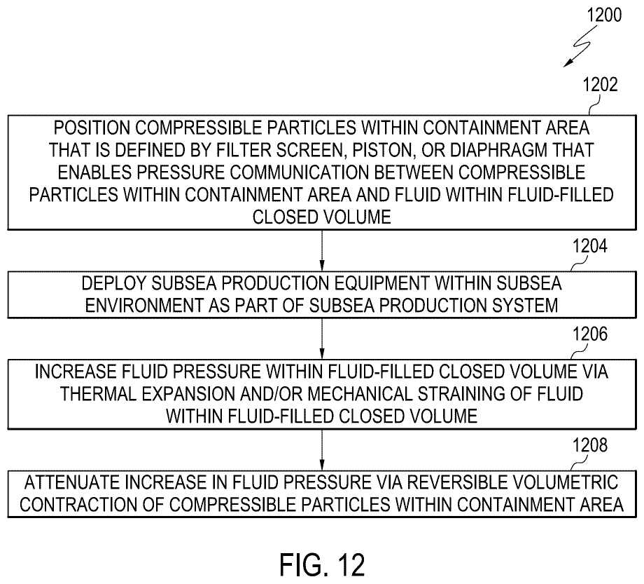

FIG. 12 is a process flow diagram of another exemplary method 1200 for managing pressure buildup within subsea production equipment using compressible particles in accordance with the present techniques. The method 1200 begins at block 1202, at which compressible particles are positioned within a containment area that is defined by a filter screen, piston, or diaphragm that enables pressure communication between the compressible particles within the containment area and fluid within a fluid-filled closed volume defined within a component of subsea production equipment. At block 1204, the subsea production equipment is deployed within a subsea environment as part of an SPS.

At block 1206, the fluid pressure within the fluid-filled closed volume is increased via thermal expansion and/or mechanical straining of the fluid within the fluid-filled closed volume. In some embodiments, this includes mechanically actuating one or more closure mechanisms that form one or more ends of the fluid-filled closed volume, resulting in mechanical straining of the fluid. Additionally or alternatively, this includes producing production fluids from one or more subsea wells corresponding to the subsea production equipment, where heat transfer between the production fluids and the fluid within the fluid-filled closed volume results in the thermal expansion of the fluid. Furthermore, at block 1208, the increase in fluid pressure is attenuated via reversible volumetric contraction of the compressible particles within the containment area.

The process flow diagrams of FIGS. 11 and 12 are not intended to indicate that the blocks of the methods 1100 and 1200, respectively, are necessarily to be executed in any particular order, or that all of the blocks of the methods 1100 and 1200 are to be included in every case. Further, any number of additional blocks not shown in FIGS. 11 and/or 12 may be included within the methods 1100 and/or 1200, depending on the details of the specific implementation.

### Embodiments of Present Techniques

In one or more embodiments, the present techniques may be susceptible to various modifications and alternative forms, such as the following embodiments as noted in paragraphs 1 to 20:

1. A method for managing pressure buildup within a component of subsea production equipment using compressible particles, the method comprising positioning compressible particles within a fluid-filled closed volume defined within a component of subsea production equipment such that an increase in fluid pressure within the fluid-filled closed volume is attenuated by reversible volumetric contraction of the compressible particles.

2. The method of paragraph 1, further comprising at least one of: forming the compressible particles from calcined petroleum coke and sulfur; providing cach compressible particle with a diameter that is in a range between 10 μm and 1300 μm (in dry state); or providing the compressible particles such that the compressible particles contract by 10% to 30% of an initial unpressurized volume of the compressible particles when increasing the fluid pressure within the fluid-filled closed volume from 15 pounds per square inch (psi) to 10,000 psi.

3. The method of paragraph 1 or 2, wherein the subsea production equipment comprises a subsea tree, a control system, a manifold, or a pipeline system deployed within a subsea environment as part of a subsea production system (SPS).

4. The method of any of paragraphs 1 to 3, wherein positioning the compressible particles within the fluid-filled closed volume comprises: providing a packing of the compressible particles; and mechanically, frictionally, or adhesively affixing the packing to an interior surface of the fluid-filled closed volume.

5. The method of paragraph 4, wherein providing the packing of the compressible particles comprises impregnating the compressible particles into a cross-linked polymer matrix.

6. The method of paragraph 4, wherein providing the packing of the compressible particles comprises encapsulating the compressible particles within an elastomeric coating.

7. The method of any of paragraphs 1 to 3, wherein positioning the compressible particles within the fluid-filled closed volume comprises positioning the compressible particles within a containment area that is defined by a filter screen, a piston, or a diaphragm that enables pressure communication between the compressible particles within the containment area and the fluid within the fluid-filled closed volume.
8. The method of any of paragraphs 1 to 3, wherein positioning the compressible particles within the fluid-filled closed volume comprises directly mixing the compressible particles into the fluid within the fluid-filled closed volume.
9. The method of any of paragraphs 1 to 8, wherein the increase in the fluid pressure within the fluid-filled closed volume is caused by at least one of thermal expansion of the fluid within the fluid-filled closed volume or mechanical straining of the fluid within the fluid-filled closed volume.
10. The method of paragraph 9, wherein at least one end of the fluid-filled closed volume is defined by a closure mechanism, and wherein the method further comprises increasing the fluid pressure within the fluid-filled closed volume by mechanically actuating the closure mechanism, resulting in the mechanical straining of the fluid within the fluid-filled closed volume.
11. The method of paragraph 9, further comprising increasing the fluid pressure within the fluid-filled closed volume by producing production fluids from at least one subsea well corresponding to the subsea production equipment, wherein heat transfer between the production fluids and the fluid within the fluid-filled closed volume results in the thermal expansion of the fluid within the fluid-filled closed volume.
12. A method for managing pressure buildup within a component of subsea production equipment using compressible particles, the method comprising: providing a packing of compressible particles by: impregnating the compressible particles into a cross-linked polymer matrix, or encapsulating the compressible particles within an elastomeric coating; affixing the packing to an interior surface of a fluid-filled closed volume that is defined within a component of subsea production equipment; deploying the subsea production equipment within a subsea environment as part of a subsea production system (SPS); increasing a fluid pressure within the fluid-filled closed volume via at least one of thermal expansion or mechanical straining of the fluid within the fluid-filled closed volume; and attenuating the increase in the fluid pressure via reversible volumetric contraction of the compressible particles within the packing.
13. The method of paragraph 12, wherein the reversible volumetric contraction of the compressible particles is within a range between 10% and 30% of an initial unpressurized volume of the compressible particles when the fluid pressure within the fluid-filled closed volume is in a range between 15 pounds per square inch (psi) and 10,000 psi.
14. The method of paragraph 12 or 13, comprising increasing the fluid pressure within the fluid-filled closed volume via mechanical straining of the fluid within the fluid-filled closed volume by mechanically actuating at least one closure mechanism that defines at least one end of the fluid-filled closed volume.
15. The method of any of paragraphs 12 to 14, comprising increasing the fluid pressure within the fluid-filled closed volume via thermal expansion of the fluid within the fluid-filled closed volume by producing production fluids from at least one subsea well corresponding to the subsea production equipment, wherein heat transfer between the production fluids and the fluid within the fluid-filled closed volume results in the thermal expansion of the fluid within the fluid-filled closed volume.
16. The method of any of paragraphs 12 to 15, wherein the subsea production equipment comprises a subsea tree, a control system, a manifold, or a pipeline system deployed within a subsea environment as part of a subsea production system (SPS).
17. A method for managing pressure buildup within a component of subsea production equipment using compressible particles, the method comprising: positioning the compressible particles within a containment area that is defined by a filter screen, a piston, or a diaphragm that enables pressure communication between the compressible particles within the containment arca and fluid within a fluid-filled closed volume defined within a component of subsea production equipment; deploying the subsea production equipment within a subsea environment as part of a subsea production system (SPS); increasing a fluid pressure within the fluid-filled closed volume via at least one of thermal expansion or mechanical straining of the fluid within the fluid-filled closed volume; and attenuating the increase in the fluid pressure via reversible volumetric contraction of the compressible particles within the containment area.
18. The method of paragraph 17, wherein the reversible volumetric contraction of the compressible particles is within a range between 10% and 30% of an initial unpressurized volume of the compressible particles when the fluid pressure within the fluid-filled closed volume is in a range between 15 pounds per square inch (psi) and 10,000 psi.
19. The method of paragraph 17 or 18, comprising increasing the fluid pressure within the fluid-filled closed volume via mechanical straining of the fluid within the fluid-filled closed volume by mechanically actuating at least one closure mechanism that defines at least one end of the fluid-filled closed volume.
20. The method of any of paragraphs 17 to 19, comprising increasing the fluid pressure within the fluid-filled closed volume via thermal expansion of the fluid within the fluid-filled closed volume by producing production fluids from at least one subsea well corresponding to the subsea production equipment, wherein heat transfer between the production fluids and the fluid within the fluid-filled closed volume results in the thermal expansion of the fluid within the fluid-filled closed volume.

While the embodiments described herein are well-calculated to achieve the advantages set forth, it will be appreciated that such embodiments are susceptible to modification, variation, and change without departing from the spirit thereof. In other words, the particular embodiments described herein are illustrative only, as the teachings of the present techniques may be modified and practiced in different but equivalent manners apparent to those skilled in the art having the benefit of the teachings herein. Furthermore, no limitations are intended on the details of formulation, construction, or design herein shown, other than as described in the claims below. Moreover, the systems and methods illustratively disclosed herein may suitably be practiced in the absence of any element that is not specifically disclosed herein and/or any optional element disclosed herein. While compositions and methods are described in terms of “comprising” or “including” various components or steps, the compositions and methods can also “consist essentially of” or “consist of” the various components and steps. Indeed, the present techniques include all alternatives, modifications, and equivalents falling within the true spirit and scope of the appended claims.

What is claimed is:

1. A method for managing pressure buildup within a component of subsea production equipment using compressible particles, the method comprising positioning compressible particles within a fluid-filled closed volume defined within a component of subsea production equipment such that an increase in fluid pressure within the fluid-filled closed volume is attenuated by reversible volumetric contraction of the compressible particles.

2. The method of claim 1, further comprising at least one of:
forming the compressible particles from calcined petroleum coke and sulfur;
providing each compressible particle with a diameter that is in a range between 10 micrometers (μm) and 1300 μm (in dry state); or
providing the compressible particles such that the compressible particles contract by 10% to 30% of an initial unpressurized volume of the compressible particles when the fluid pressure within the fluid-filled closed volume is increased from 15 pounds per square inch (psi) to 10,000 psi.

3. The method of claim 1, wherein the subsea production equipment comprises a subsea tree, a control system, a manifold, or a pipeline system deployed within a subsea environment as part of a subsea production system.

4. The method of claim 1, wherein positioning the compressible particles within the fluid-filled closed volume comprises:
providing a packing of the compressible particles; and
mechanically, frictionally, or adhesively affixing the packing to an interior surface of the fluid-filled closed volume.

5. The method of claim 4, wherein providing the packing of the compressible particles comprises impregnating the compressible particles into a cross-linked polymer matrix.

6. The method of claim 4, wherein providing the packing of the compressible particles comprises encapsulating the compressible particles within an elastomeric coating.

7. The method of claim 1, wherein positioning the compressible particles within the fluid-filled closed volume comprises positioning the compressible particles within a containment area that is defined by a filter screen, a piston, or a diaphragm that enables pressure communication between the compressible particles within the containment area and the fluid within the fluid-filled closed volume.

8. The method of claim 1, wherein positioning the compressible particles within the fluid-filled closed volume comprises directly mixing the compressible particles into the fluid within the fluid-filled closed volume.

9. The method of claim 1, wherein the increase in the fluid pressure within the fluid-filled closed volume is caused by at least one of thermal expansion of the fluid within the fluid-filled closed volume or mechanical straining of the fluid within the fluid-filled closed volume.

10. The method of claim 9, wherein at least one end of the fluid-filled closed volume is defined by a closure mechanism, and wherein the method further comprises increasing the fluid pressure within the fluid-filled closed volume by mechanically actuating the closure mechanism, resulting in the mechanical straining of the fluid within the fluid-filled closed volume.

11. The method of claim 9, further comprising increasing the fluid pressure within the fluid-filled closed volume by producing production fluids from at least one subsea well corresponding to the subsea production equipment, wherein heat transfer between the production fluids and the fluid within the fluid-filled closed volume results in the thermal expansion of the fluid within the fluid-filled closed volume.

12. A method for managing pressure buildup within a component of subsea production equipment using compressible particles, the method comprising:
providing a packing of compressible particles by:
impregnating the compressible particles into a cross-linked polymer matrix, or
encapsulating the compressible particles within an elastomeric coating;
affixing the packing to an interior surface of a fluid-filled closed volume that is defined within a component of subsea production equipment;
deploying the subsea production equipment within a subsea environment as part of a subsea production system;
increasing a fluid pressure within the fluid-filled closed volume via at least one of thermal expansion or mechanical straining of the fluid within the fluid-filled closed volume; and
attenuating the increase in the fluid pressure via reversible volumetric contraction of the compressible particles within the packing.

13. The method of claim 12, wherein the reversible volumetric contraction of the compressible particles is within a range between 10% and 30% of an initial unpressurized volume of the compressible particles when the fluid pressure within the fluid-filled closed volume is in a range between 15 pounds per square inch (psi) and 10,000 psi.

14. The method of claim 12, comprising increasing the fluid pressure within the fluid-filled closed volume via mechanical straining of the fluid within the fluid-filled closed volume by mechanically actuating at least one closure mechanism that defines at least one end of the fluid-filled closed volume.

15. The method of claim 12, comprising increasing the fluid pressure within the fluid-filled closed volume via thermal expansion of the fluid within the fluid-filled closed volume by producing production fluids from at least one subsea well corresponding to the subsea production equipment, wherein heat transfer between the production fluids and the fluid within the fluid-filled closed volume results in the thermal expansion of the fluid within the fluid-filled closed volume.

16. The method of claim 12, wherein the subsea production equipment comprises a subsea tree, a control system, a manifold, or a pipeline system deployed within a subsea environment as part of a subsea production system.

17. A method for managing pressure buildup within a component of subsea production equipment using compressible particles, the method comprising:
positioning the compressible particles within a containment area that is defined by a filter screen, a piston, or a diaphragm that enables pressure communication between the compressible particles within the containment area and fluid within a fluid-filled closed volume defined within a component of subsea production equipment;
deploying the subsea production equipment within a subsea environment as part of a subsea production system;
increasing a fluid pressure within the fluid-filled closed volume via at least one of thermal expansion or mechanical straining of the fluid within the fluid-filled closed volume; and
attenuating the increase in the fluid pressure via reversible volumetric contraction of the compressible particles within the containment area.

18. The method of claim 17, wherein the reversible volumetric contraction of the compressible particles is within a range between 10% and 30% of an initial unpressurized volume of the compressible particles when the fluid pressure within the fluid-filled closed volume is in a range between 15 pounds per square inch (psi) and 10,000 psi.

19. The method of claim 17, comprising increasing the fluid pressure within the fluid-filled closed volume via mechanical straining of the fluid within the fluid-filled closed volume by mechanically actuating at least one closure mechanism that defines at least one end of the fluid-filled closed volume.

20. The method of claim 17, comprising increasing the fluid pressure within the fluid-filled closed volume via thermal expansion of the fluid within the fluid-filled closed volume by producing production fluids from at least one subsea well corresponding to the subsea production equipment, wherein heat transfer between the production fluids and the fluid within the fluid-filled closed volume results in the thermal expansion of the fluid within the fluid-filled closed volume.
